(19) United States
(12) Patent Application Publication
(10) Pub. No.: US 2023/0035934 A1
(43) Pub. Date: Feb. 2, 2023

(54) Tire with Belt Package Reinforcement Element

(71) Applicant: BRIDGESTONE EUROPE NV/SA, Zaventem (BE)

(72) Inventors: Marco Colletti, Roma (IT); Luca Spiri, Roma (IT)

(21) Appl. No.: 17/786,010

(22) PCT Filed: Dec. 17, 2020
(86) PCT No.: PCT/IB2020/062094

§ 371 Date: Jun. 16, 2022

(30) Foreign Application Priority Data
Dec. 18, 2019 (IT) 102019000024442

(51) Int. Cl. B60C 9/18; B60C 9/00

(52) U.S. Cl. CPC B60C 9/1807; B60C 9/0042; B60C 2009/1814; B60C 2009/0071

(57) ABSTRACT

Tyre comprising a carcass, a belt package and a tread; said tyre comprising at least a reinforcement net made of a weaved textile material having a number of meshes ranging from 3 to 20, and wherein the threads are oriented between 25° and 65° relative to a longitudinal axis (X) of the tyre; said reinforcement net being arranged at least in the area of a centre of the tread and positioned inside the belt package or between the belt package and the tread; said weaved textile material having an elongation at break equal to or greater than 10%; said reinforcement net having a shorter transverse extension than the one of the belt package.

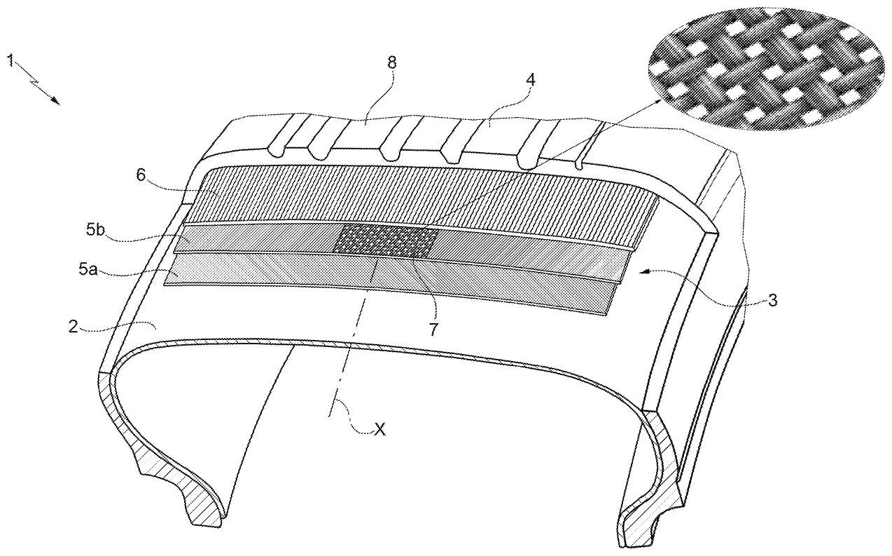

The invention relates to a tire comprising a fabric ply designed to support the belt package.

As a person skilled in the art knows, tires comprise a belt package, which generally consists of steel belts and of a cap ply. Steel belts basically create a steel net, which basically forms the reinforcement of the wheels.

The aim of steel belts in radial tires is that of stabilizing the carcass in the area in which the tire interacts with the road, so as to correctly and effectively transmit the steering commands from the steering wheel to the road. Anyone can immediately understand that a damage to the steel belts can cause problems to the normal operation of the tire.

For a long time ago, in the tire field the need has been felt for tires with the technical characteristics able to guarantee a greater durability. As it is known to a skilled person of the field, one of the elements that most guarantees the durability of the tires is the resistance of the belt package.

In order to improve the resistance of the belt package, manufacturers usually add heavy reinforcement elements and/or change the materials thereof. Such a solution, although it is able to guarantee greater resistance, leads however to a drawback concerning a weight increase, with a consequent worsening of the rolling resistance and a tyro tire cost increase.

In order to verify the resistance of the belt package, a test known as “plunger test” is used. This test basically measures the resistance of the tire belt package to the impacts that the tire undergoes during its operation. In particular, this test involves the use of a plunger with a rounded tip, which forces the central area of the tread of an inflated tire. By so doing, one can measure the energy needed to penetrate the carcass.

Therefore, there is a need for a solution capable of ensuring an improvement in terms of resistance of the belt package, without for this reason being affected by those drawbacks that are typical of the prior art and concern a tire weight and cost increase.

The subject-matter of the invention is a tire comprising a carcass, a belt package and a tread; said tire being characterized in that it comprises at least a reinforcement net made of a weaved textile material having a number of meshes ranging from 3 to 20, and wherein the threads are oriented between 25° and 65° relative to a longitudinal direction of the tire; said reinforcement net being arranged at least in the area of a centre of the tread and positioned inside the belt package or between the belt package and the tread; said weaved textile material having an elongation at break equal to or greater than 10%; said reinforcement net having a shorter transverse extension than the one of the belt package.

“Meshes” are units of measurement corresponding to the number of meshes per linear inch.

In the present application “weaved textile material” means a material in which the threads are intertwined without constraints such as knots or the like. That is, each thread is free to slide over the others.

This weaved textile material must be able to easily expand itself under application of a perpendicular load (an external input like just for example a stone on the road) such spreading the external load input on wider number of below steelcord. If the material comprised knots between threads (or even similar shape that block the relative movement among threads) this would be reflected into a concentration of stress on the singular knot and, accordingly, on a single point of the belt package below, with opposite effect of the purpose of the invention.

In case the reinforcement net has a number of meshes smaller than the one indicated above, it loses its efficiency in terms of increase of the energy needed to penetrate the belt package. Indeed, should the number of meshes smaller than the range indicated above, the reinforcement net cannot ensure an effective distribution of the forces on the belt package. While, in case the reinforcement net has a number of meshes greater than the range indicated above, no further increase of the energy needed to penetrate the belt package is obtainable and, at the same time, there are disadvantages in terms of productivity, weight, cost and irregular wear of the tread. The latter disadvantage, as may be immediate to a skilled man of the art, derives from the excessive stiffness of the reinforcement net.

Preferably, the reinforcement net has a number of meshes ranging from 8 to 16, and more preferably from 12 to 16.

Furthermore, the orientation of the threads of the reinforcement net, as defined above, ensures that, during the tire vulcanization step, the reinforcement net can stretch without being subjected to a harmful tensioning.

Furthermore, it has been experimentally proved that when the weaved textile material has an elongation at break smaller than 10%, the reinforcement net has not enough elasticity needed to spread plunger load on wider area.

The reinforcement net is preferably made of a weaved textile material with an elongation at break equal to or greater than 15%, and more preferably equal to or greater than 20%.

The reinforcement net is preferably made of Nylon.

Preferably, the belt package comprises at least a pair of steel belts and the reinforcement net is positioned on the steel belt closest to the tread. Alternatively, the belt package comprises also a cap ply and the reinforcement net is preferably positioned between the steel belt closest to the tread and the cap ply.

Said reinforcement net preferably is covered with an adhesive substance to guarantee adhesion between the reinforcement net and a surrounding rubber.

The invention will now be described with reference to the accompanying drawing, which shows, by mere way of explanatory and non-limiting example, an embodiment thereof.

The FIGURE shows a portion of a tire according to the invention with parts removed for greater clarity.

In the FIGURE, number 1 indicates, as a whole, a tire comprising a carcass 2, a belt package 3 and a tread 4. In particular, the belt package 3 comprises a pair of steel belts 5a and 5b and a cap ply 6.

The tire 1 comprises a reinforcement net 7 arranged between the second steel belt 5b and the cap ply 6.

The reinforcement net 7 has a smaller transverse extension than the one of the belt package and is arranged in the area of a central rib 8 of the tread 4.

The reinforcement net 7 is made of Nylon and has threads oriented at 45° relative to a longitudinal axis X of the tire. Nylon has an elongation at break of 20%.

In particular, the reinforcement net 7 has a number of mesh of 12, a width of 100 mm, a gauge of 0.6 mm and threads of 6.6 Nylon characterized by 940 dtex and EPDM 47.

The reinforcement net before being mounted on the tire was covered with RFL resin as adhesive substance, in order to guarantee the adhesion of the net with surrounding rubber.

The tire 1 comprising the reinforcement net 7 was subjected to the plunger test according to FMVSS 139 American standard under Extra load tire condition with tire 195/55R16.

For comparison, the same test was performed on a comparison tire, which differs from the tire of the invention solely because it is devoid of the reinforcing net 7.

The plunger test showed for the tire of the present invention an energy higher than that found for the comparison tire.

In particular, indexing the energy value obtained with the comparison tire(without reinforcement net) to 100, the energy value obtained with the tire of the invention amounts to 123.

The energy increase obtained with the tire of the invention derives from the resistance produced by the reinforcement net per se only to a minimum extent (14% of the total improvement from the comparison tire), whereas, to a much greater extent, it derives from the effect, generated by the reinforcement net itself, of dissipation of the load on the steel belts.

Obviously, the above dissipation is possible only if the weaved textile material has an elongation at break such as to be flexible enough to spread external input on wider steel cord area. In fact, if the weaved textile material breaks (low elongation break) it will not be able to have enough spreading effect.

In order to demonstrate that the elongation at break of weaved textile materials plays an essential role for the effectiveness of the invention, the inventors made a comparison between reinforcement nets made of Nylon and reinforcement nets made of a Nylon/Aramid hybrid.

The elongation at break of Nylon/Aramid hybrid is 4.5%.

The comparison has been carried out by FEM Simulation using the following conditions:
Net strip width:25 mm
Net strip gauge:0.6 mm
Net angle: 2strip×45°
Fabric type:
   Nylon(1400/2) at different EPDM: 100,47,13 with E (Modulus)=3.544×10⁵ psi
   Hybrid (Aramid: 1670/2 +Nylon: 940/1) at different EPDM: 100,47,13 with E (Modulus)=2.5×10⁶ psi
Tire size: 195/65R15
Rubber skim modulus: E(modulus)=8.261×10² psi, Poisson ratio:0.4950
Rubber Tread Modulus: E(modulus)=8.657×10² psi, Poisson ratio:0.4950

In Table I plunger simulation data (FEM simulation) are shown.

The results of table I are indexed to the tire without reinforcement net.

TABLE I

| | |
|---|---|
| Tire without reinforcement net | 100% |
| Tire with Nylon reinforcement net (3 Mesh) | 109.8% |
| Tire with Nylon reinforcement net (12 Mesh) | 112.6% |
| Tire with Hybrid reinforcement net (3 Mesh) | 107.6% |
| Tire with Hybrid reinforcement net (12 Mesh) | 110.5% |

Owing to the above, it is evident that the solution suggested by this invention can ensure an improvement of the tire in terms of higher energy values in the plunger test.

This result is necessarily associated with a greater resistance of the belt package of the tire, which automatically translates into a longer life thereof.

1-8. (canceled)

9. A tire comprising:
a carcass;
a belt package;
a tread;
a reinforcement net comprising a weaved textile material having a number of meshes ranging from 3 to 20, and wherein threads thereof are oriented between 25° and 65° relative to a longitudinal axis of the tire;
wherein the reinforcement net is arranged in a central area of the tread and positioned inside the belt package or between the belt package and the tread;
wherein the weaved textile material has an elongation at break equal to or greater than 10%; and
wherein the reinforcement net has a shorter transverse extension than a transverse extension of the belt package.

10. The tire of claim 9, wherein the reinforcement net is arranged proximate a central rib of the tread.

11. The tire of claim 9, wherein the reinforcement net comprising a weaved textile material has a number of meshes ranging from 8 to 16.

12. The tire of claim 10, wherein the reinforcement net comprising a weaved textile material has a number of meshes ranging from 12 to 16.

13. The tire of claim 9, wherein the reinforcement net comprises a weaved textile material with an elongation at break equal to or greater than 15%.

14. The tire of claim 9, wherein the reinforcement net comprises a weaved textile material with an elongation at break equal to or greater than 20%.

15. The tire of claim 9, wherein the reinforcement net is made of Nylon.

16. The tire of claim 9, wherein the belt package comprises at least a pair of steel belts and the reinforcement net is positioned on a steel belt of the pair of steel belts that is closest to the tread.

17. The tire of claim 9, wherein the belt package comprises at least a pair of steel belts and a cap ply, and the reinforcement net is positioned between a steel belt of the pair of steel belts that is closest to the tread and the cap ply.

18. The tire of claim 9, wherein the reinforcement net is covered with an adhesive substance configured to guarantee adhesion between the reinforcement net and a surrounding rubber.
